(19) United States
(12) Patent Application Publication
(10) Pub. No.: US 2015/0170674 A1
(43) Pub. Date: Jun. 18, 2015

(54) INFORMATION PROCESSING APPARATUS, INFORMATION PROCESSING METHOD, AND PROGRAM

(71) Applicant: SONY CORPORATION, Tokyo (JP)

(72) Inventor: YOSHIHITO ISHIBASHI, TOKYO (JP)

(21) Appl. No.: 14/564,284

(22) Filed: Dec. 9, 2014

(30) Foreign Application Priority Data
Dec. 17, 2013 (JP) 2013-260462

(51) Int. Cl. G10L 25/51

(52) U.S. Cl. CPC G10L 25/51

(57) ABSTRACT

There is provided an information processing apparatus including an index calculating section configured to calculate a quantitative index relevant to conversation constituted by speech sound acquired by a microphone put in a living environment of a user, and an information generating section configured to generate information indicating a characteristic of the living environment on the basis of the quantitative index.

### CROSS REFERENCE TO RELATED APPLICATIONS

This application claims the benefit of Japanese Priority Patent Application JP 2013-260462 filed Dec. 17, 2013, the entire contents of which are incorporated herein by reference.

### BACKGROUND

The present disclosure relates to an information processing apparatus, an information processing method, and a program.

In the past, the data relevant to the living environment has been collected mainly by a medical interview of a medical doctor and the like. However, when the data is collected by a medical interview, the subjective views of both a medical doctor who is asking questions and a patient who is answering the questions affect the data, making it difficult to collect objective data. In contrast, JP 2010-158267A, for example, discloses the technology to acquire objective information relevant to the form of the lifestyle habits of a user, such as getting up, sleeping, eating, exercising, on the basis of data output from an acceleration sensor, a heartbeat sensor, and an optical sensor. For example, this technology allows the life activity condition of an individual patient to be recorded over a long period of time and is expected to make it possible for medical doctors to diagnose objectively on the basis of the recorded information.

### SUMMARY

However, in the technology described in JP 2010-158267A for example, since the form of the lifestyle habits is estimated on the basis of physiological or physical data such as the movement and the pulse of the body of the user and the amount of light in the surrounding environment, it is difficult to acquire information indicating the characteristic of the living environment in which the data is unlikely to change for example.

Therefore, in the present disclosure, a novel and improved information processing apparatus, information processing method, and program capable of collecting the information indicating the characteristic of the living environment of the user are proposed from a new point of view.

According to an embodiment of the present disclosure, there is provided an information processing apparatus including an index calculating section configured to calculate a quantitative index relevant to conversation constituted by speech sound acquired by a microphone put in a living environment of a user, and an information generating section configured to generate information indicating a characteristic of the living environment on the basis of the quantitative index.

According to another embodiment of the present disclosure, there is provided an information processing method including calculating, by a processor, a quantitative index relevant to conversation constituted by speech sound acquired by a microphone put in a living environment of a user, and generating, by the processor, information indicating a characteristic of the living environment on the basis of the quantitative index.

According to another embodiment of the present disclosure, there is provided a program for causing a computer to implement a function to calculate a quantitative index relevant to conversation constituted by speech sound acquired by a microphone put in a living environment of a user, and a function to generate information indicating a characteristic of the living environment on the basis of the quantitative index.

As described above, according to the present disclosure, the information indicating the characteristic of the living environment of the user is collected from a new point of view. Note that the above effects are not necessarily restrictive, but any effect described in the present specification or another effect that can be grasped from the present specification may be achieved in addition to the above effects or instead of the above effects.

### BRIEF DESCRIPTION OF THE DRAWINGS

FIG. 1 is a diagram for describing a sound acquisition in a living environment of a user in an embodiment of the present disclosure;

FIG. 2 is a diagram illustrating a schematic configuration of a system according to an embodiment of the present disclosure;

FIG. 3 is a diagram illustrating a schematic configuration of a processing unit in an embodiment of the present disclosure;

FIG. 4 is a flowchart illustrating an example of a process to identify a speaker of a speech sound in an embodiment of the present disclosure;

FIG. 5 is a flowchart illustrating an example of a process to identify a conversation segment in an embodiment of the present disclosure; and

FIG. 6 is a block diagram illustrating an exemplary hardware configuration of an information processing apparatus according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be made in the following order:

### 1. System Configuration

### 2. Configuration of Processing Unit

### 3. Process Flow

3-1. Identification of Speaker

3-2. Identification of Conversation Segment

### 4. Exemplary Application

4-1. Conversation Duration

4-2. Sound Volume of Conversation

4-3. Speed of Conversation

4-4. Utilization of Data

### 5. Hardware Configuration

### 6. Supplement

(1. System Configuration)

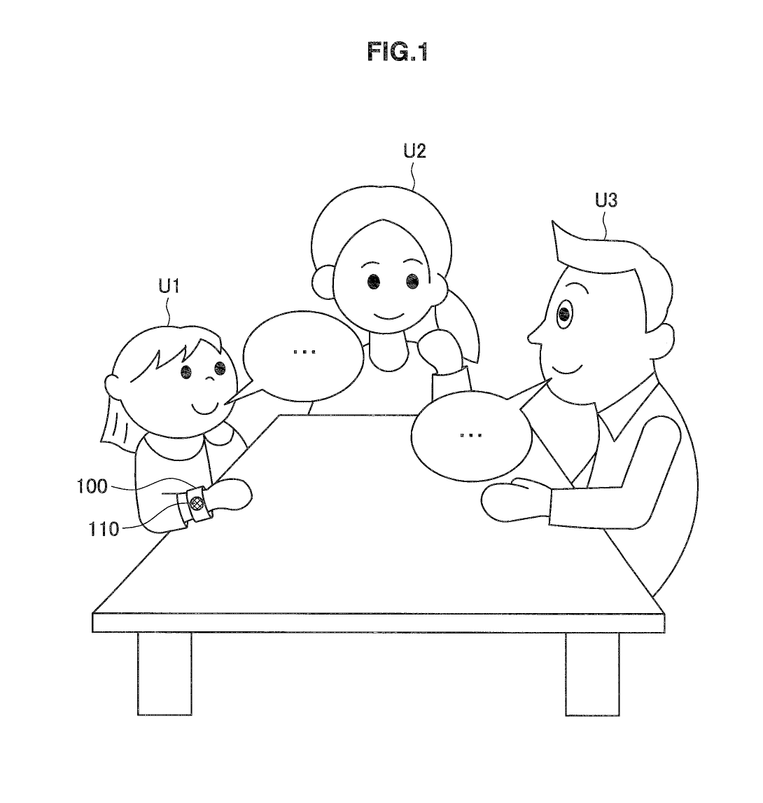

FIG. 1 is a diagram for describing sound acquisition in a living environment of a user in an embodiment of the present disclosure. Referring to FIG. 1, in the present embodiment, the sound in the living environment of the user is acquired by a wearable terminal 100.

The wearable terminal 100 includes a microphone 110. The microphone 110 is put in the living environment of the user U1, to acquire the sound generated there. In order to exhaustively acquire the sound generated in the living environment of the user U1, it is desirable to use the wearable terminal 100 that can be worn by the user U1. However, the user U1 may use a portable mobile terminal, instead of or together with the wearable terminal 100. Also, for example, when the living environment of the user U1 is limited (in the case of an infant which does not sit up from a bed yet, and the like), the sound can be acquired with a microphone of a stationary terminal device. Note that the wearable terminal 100 may be designed to perform the acquisition of the sound data according to the present embodiment as a main function, or may perform the acquisition of the sound data according to the present embodiment as one of a plurality of functions of the wearable terminal 100.

Here, the sound acquired by the microphone 110 of the wearable terminal 100 includes speech sound between a user U1 and users U2, U3 who are other users present in the living environment of the user U1. The speech sound constitutes conversation. For example, when the user U1 has a conversation with the user U2, the speech sound of the user U1 and the speech sound of the user U2 are alternately acquired by the microphone 110. Also, when the user U2 has a conversation with the user U3, the speech sound of the user U2 and the speech sound of the user U3 are alternately acquired by the microphone 110.

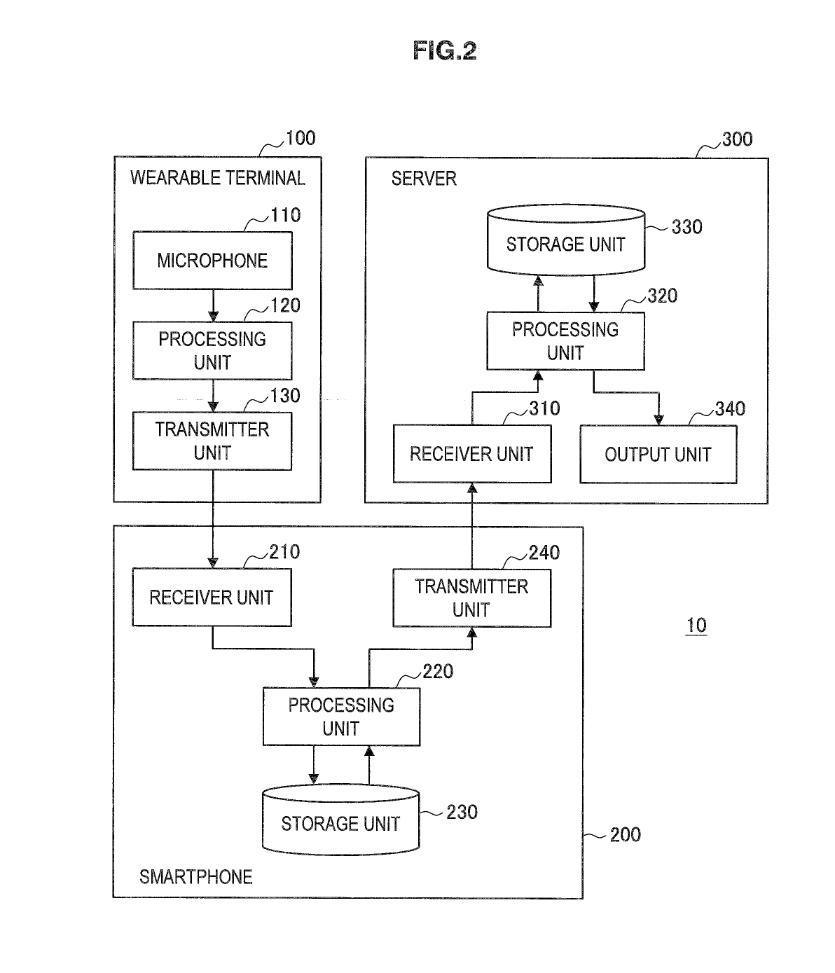

FIG. 2 is a diagram illustrating the schematic configuration of the system according to an embodiment of the present disclosure. Referring to FIG. 2, the system 10 includes a wearable terminal 100, a smartphone 200, and a server 300. Note that the exemplary hardware configuration of the information processing apparatus to realize each of the devices will be described later.

The wearable terminal 100 includes a microphone 110, a processing unit 120, and a transmitter unit 130. The microphone 110 is put in the living environment of the user, as described above with reference to FIG. 1. The processing unit 120 is realized by a processor such as a CPU for example, and processes the sound data acquired by the microphone 110. The process by the processing unit 120 may be preprocessing such as sampling and denoising for example, and the process such as sound analysis and calculation of a quantitative index described later may be executed in the processing unit 120. The transmitter unit 130 is realized by a communication device, and transmits, to the smartphone 200, the sound data (or the data after analysis) utilizing wireless communication such as Bluetooth (registered trademark) for example.

The smartphone 200 includes a receiver unit 210, a processing unit 220, a storage unit 230, and a transmitter unit 240. The receiver unit 210 is realized by a communication device, and receives the sound data (or the data after analysis) transmitted from the wearable terminal 100 by utilizing the wireless communication such as Bluetooth (registered trademark). The processing unit 220 is realized by a processor such as a CPU for example, and processes the received data. For example, the processing unit 220 may transmit the received data via the transmitter unit 240 to the server 300, after temporarily accumulating the received data in the storage unit 230. The storage unit 230 is realized by a memory and a storage, for example. The transmitter unit 240 is realized by a communication device, and transmits, to the server 300, the sound data (or the data after analysis) utilizing network communication such as the Internet, for example. The processing unit 220 may execute process such as sound analysis and calculation of the quantitative index described later, as well as control of the above accumulation and transmission.

Note that the smartphone 200 is not necessarily limited to a smartphone, but can be replaced by other various terminal devices, in order to realize the function to accumulate or process the sound data (or the data after analysis) acquired in the wearable terminal 100 as necessary and thereafter forward the sound data (or the data after analysis) to the server 300. For example, the smartphone 200 may be replaced by a tablet terminal, various types of personal computers, a wireless network access point, and the like. Alternatively, the smartphone 200 may not be included in the system 10, if the wearable terminal 100 has a network communication function and is capable of transmitting the sound data (or the data after analysis) to the server 300 directly, for example.

The server 300 includes a receiver unit 310, a processing unit 320, a storage unit 330, and an output unit 340. The receiver unit 310 is realized by a communication device, and receives the sound data (or the data after analysis) transmitted from the smartphone 200 by utilizing network communication such as the Internet. The processing unit 320 is realized by a processor such as a CPU for example, and processes the received data. For example, the processing unit 320 may temporarily accumulate the received data in the storage unit 330, and thereafter execute process such as the sound analysis and the calculation of the quantitative index described later, in order to further accumulate the data after analysis in the storage unit 330, or in order to output the data after analysis via the output unit 340. When the process such as the sound analysis and the calculation of the quantitative index is executed in the wearable terminal 100 or the smartphone 200, the processing unit 320 may execute only the accumulation of the data after analysis and the control of the output.

As described above, the roles of the processing units 120, 220, 320 change depending on throughput of each device, the memory capacity, and/or the communication environment and the like. For that reason, the role of each of the processing units described above may be changed or exchanged. As one example, the processing unit 120 may execute the entire analysis process, and thereafter transmit the data after analysis to the server 300. Also, for example, it may be such that the sound data is once transmitted to the server 300, and thereafter the server 300 executes preprocessing and returns the data after the processing to the smartphone 200, and the smartphone 200 executes the final analysis process and outputs the information via the wearable terminal 100. Also, for example, it may be such that the wearable terminal 100 collects the sound data and the like and transmits the collected data via the smartphone 200 to the server 300, and the processing unit 320 of the server 300 executes the fundamental analysis process and transmits the data after analysis to the smartphone 200. Like this, the role of each device in the system can be different from the configuration illustrated above.

(2. Configuration of Processing Unit)

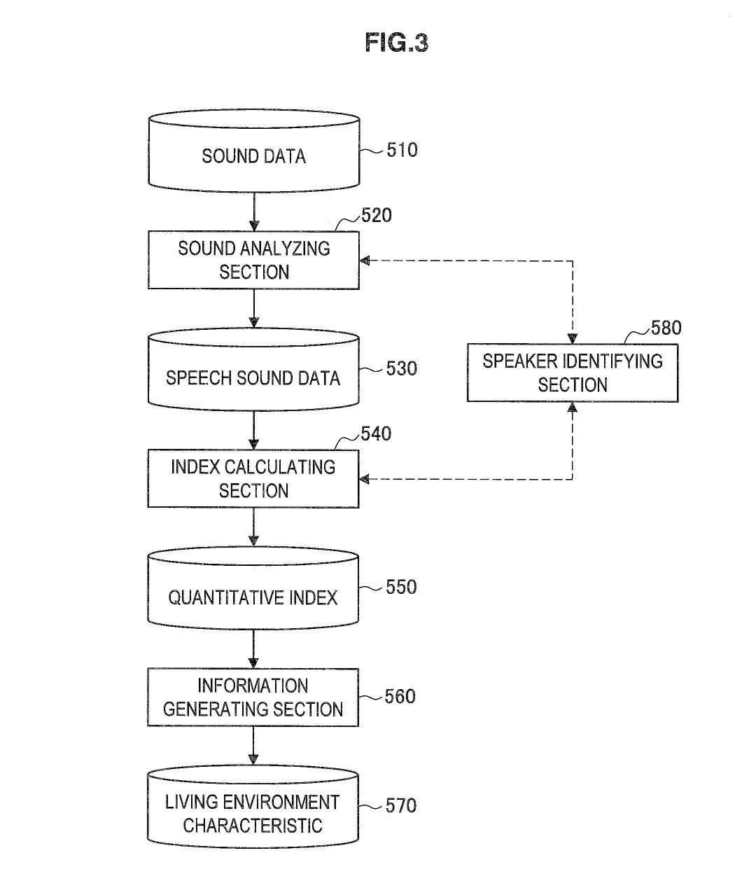

FIG. 3 is a diagram illustrating the schematic configuration of the processing unit in an embodiment of the present disclosure. Referring to FIG. 3, the processing unit according to the present embodiment includes a sound analyzing section 520, an index calculating section 540, an information generating section 560, and a speaker identifying section 580.

Here, the sound analyzing section 520, the index calculating section 540, the information generating section 560, and the speaker identifying section 580 are implemented in the processing unit 120 of the wearable terminal 100, the processing unit 220 of the smartphone 200, or the processing unit 320 of the server 300 in the system 10, which are described above with reference to FIG. 2, for example. The entire processing unit may be realized in a single device, or may be realized in such a manner that one or more components are separated in respective different devices.

The sound data 510 is acquired by the microphone 110 of the wearable terminal 100. As described above, since the microphone 110 is put in the living environment of the user, the sound data 510 includes various sound generated around the user. For example, the sound data 510 includes the speech sound that constitutes the conversation between the user and another user (in an example of FIG. 1, the conversation between the user U1 and the user U2 or the user U3), and the conversation between other users near the user (in an example of FIG. 1, the conversation between the user U2 and the user U3).

The sound analyzing section 520 acquires speech sound data 530, by analyzing the sound data 510. For example, the sound analyzing section 520 may acquire the speech sound data 530, by cutting out a segment of the speech sound from the sound data 510. In this case, for example, the speech sound data 530 can be acquired by cutting out a segment of a series of conversation by the speech sound of a plurality of users. When at least one of speakers of the speech sound is identified by the speaker identifying section 580 described later, the sound analyzing section 520 may add the information indicating the speaker of the speech sound for each segment, to the speech sound data 530. Note that, since the publicly-known various technologies can be utilized in the process to cut out the segment of the speech sound from the sound data, the detailed description will be omitted.

The index calculating section 540 calculates the quantitative index 550 relevant to the conversation constituted by the speech sound, by analyzing the speech sound data 530. Here, as described above, the speech sound is acquired by the microphone put in the living environment of the user. The quantitative index 550 may include, for example, the total time of the conversation, the sound volume, the speed, and the like. When segments of a series of conversation by the speech sound of a plurality of users are cut out from the speech sound data 530, and in addition the information indicating the speaker of the speech sound for each segment is added, the index calculating section 540 may calculate the above quantitative index 550 for each participant of the conversation. Alternatively, the index calculating section 540 may provide the speech sound data 530 to the speaker identifying section 580, and calculate the quantitative index 550 for each participant of the conversation on the basis of the result of identifying the speaker of the speech sound by the speaker identifying section 580. Also, the index calculating section 540 may calculate the quantitative index 550 for the entire conversation, regardless of the participants of the conversation.

Here, in the present embodiment, the index calculating section 540 does not take into consideration the content of the speech, when calculating the quantitative index 550 from the speech sound data 530. That is, in the present embodiment, the index calculating section 540 does not execute the process of the sound recognition for the speech sound data 530 when calculating the quantitative index 550. As a result, the content of the conversation is masked in the calculated quantitative index 550. Accordingly, the quantitative index 550 in the present embodiment can be handled as the data that does not violate the privacy of the user. As a matter of course, the sound data 510 itself can be recorded, or the sound recognition process can be executed to analyze and record the speech content as the text information. In that case as well, for example, in order to protect the privacy and the business confidential information and the like of the user, the information recorded in accordance with the request and the like of the user may be deleted, for example.

The information generating section 560 generates the living environment characteristic 570 on the basis of the quantitative index 550. The living environment characteristic 570 is the information indicating the characteristic of the living environment of the user. For example, the information generating section 560 may generate the living environment characteristic 570 on the basis of the total time for each participant of the conversation, on the basis of the quantitative index 550 including the total time of the conversation generated in the living environment of the user. At this time, the total time of the conversation may be calculated every unit period, and the information generating section 560 may generate the living environment characteristic 570 on the basis of the variation tendency of the total time. Also, for example, the information generating section 560 may generate the living environment characteristic 570, on the basis of the quantitative index 550 including the sound volume or the speed of the conversation, and on the basis of the duration of time or the number of times when the sound volume or the speed of the conversation of each participant exceeds a normal range. Note that a specific example of the information to be generated as the living environment characteristic 570 will be described later.

The speaker identifying section 580 identifies at least one of the speakers of the speech sound included in the sound data 510 or the speech sound data 530. For example, the speaker identifying section 580 identifies the speaker by comparing the feature of the voice of the individual user which is registered in advance with the feature of the speech sound. For example, the speaker identifying section 580 may identify the user and the members of the family of the user, as the speaker. As above, the speaker identifying section 580 identifies the speaker of the speech sound, so that the index calculating section 540 calculates the quantitative index 550 relevant to the conversation, for each participant of the conversation. Note that the speaker identifying section 580 may not necessarily identify all speakers of the speech sound.

For example, the speaker identifying section 580 may recognize the speech sound having the feature not identical with the feature registered in advance, as the speech sound by another speaker. In this case, another speaker can include a plurality of different speakers. As a matter of course, the speaker having the feature of the speech sound not identical with the feature registered in advance may be automatically identified and registered, depending on the situation. In this case, the personal information such as the name of the speaker is not necessarily identified. However, since the feature of the speech sound is extracted, the feature can be utilized to classify the speech sound and generate the living environment characteristic 570. At a later date, for example, when the personal information of an unidentified speaker is identified by the information input by the user, the previously recorded information may be updated.

(3. Process Flow)

(3-1. Identification of Speaker)

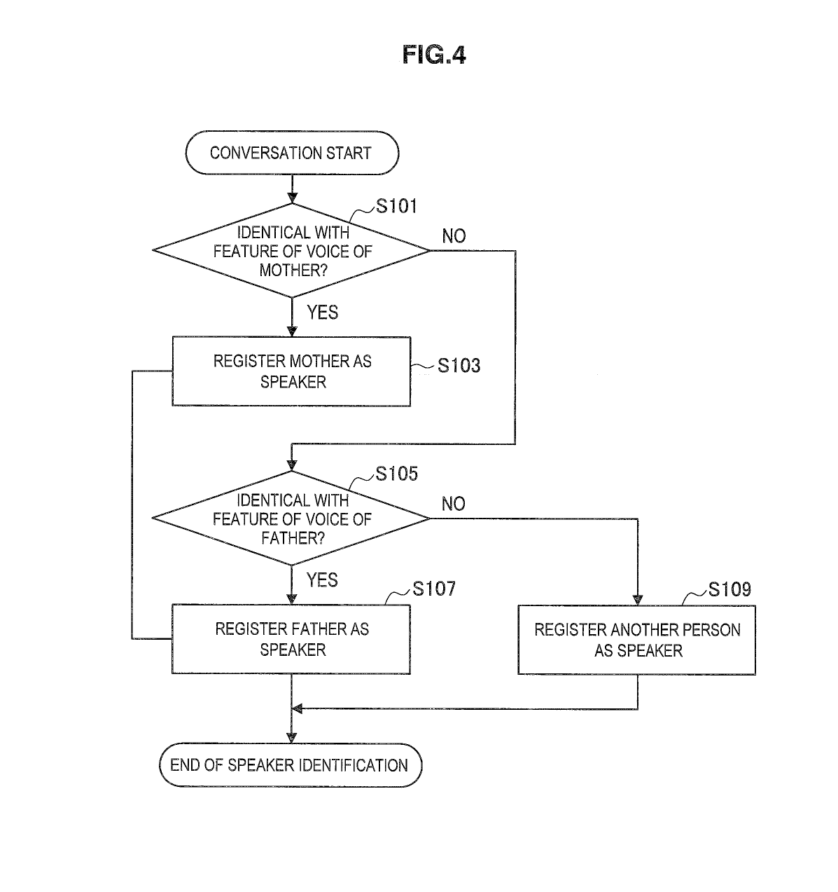

FIG. 4 is a flowchart illustrating an example of the process to identify the speaker of the speech sound in an embodiment of the present disclosure. Note that, in an example illustrated in the drawing, the case in which the speaker is a mother or a father is identified. However if the feature of the voice is registered, other speakers such as a brother, a friend, a school teacher can be identified. Referring to FIG. 4, after the start of the conversation, the speaker identifying section 580 compares the feature of the speech sound included in the sound data 510 or the speech sound data 530, with the feature of the voice of the mother which is registered in advance (S101). Here, if the feature of the speech sound is identical with the feature of the voice of the mother (YES), the speaker identifying section 580 registers the mother as the speaker of the speech sound (S103). Note that, since the publicly-known various technologies can be utilized in the process of the feature comparison of the sound, the detailed description will be omitted.

On the other hand, in S101, if the feature of the speech sound is not identical with the feature of the voice of the mother (NO), the speaker identifying section 580 compares the feature of the speech sound, with the feature of the voice of the father which is registered in advance (S105). Here, if the feature of the speech sound is identical with the feature of the voice of the father (YES), the speaker identifying section 580 registers the father as the speaker of the speech sound (S107). On the other hand, in S105, if the feature of the speech sound is not identical with the feature of the voice of the father, either (NO), the speaker identifying section 580 registers another person as the feature of the speech sound (S109). Although not depicted here, a person other than the mother and the father may be identified and registered. The speaker identifying process ends here.

(3-2. Identification of Conversation Segment)

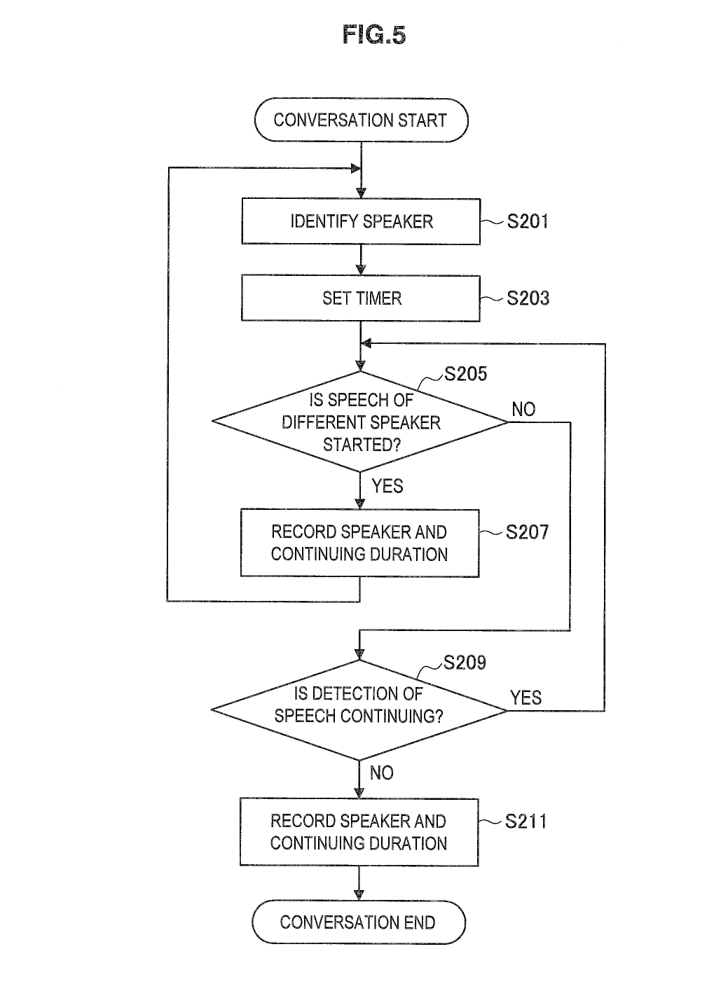

FIG. 5 is a flowchart illustrating an example of the process to identify a conversation segment in an embodiment of the present disclosure. In the present embodiment, for example, the sound analyzing section 520 identifies the segment of the conversation constituted by the speech sound included in the sound data 510. More specifically, when extracting the speech sound data 530, the sound analyzing section 520 identifies the segment from a start of the first speech by the user participating in the conversation to the end of the last speech by the user likewise participating in the conversation, as the conversation segment. For example, the continuing duration of the conversation can be calculated, by measuring the length of the conversation segment.

Referring to FIG. 5, upon detecting the start of the conversation at the time point when the speech is started in the sound data 510, the sound analyzing section 520 identifies the speaker using the speaker identifying section 580 (S201), and activates a timer (S203). Thereafter, the sound analyzing section 520 determines, in the sound data 510, whether or not a speech by a speaker different from the speaker who first started a speech is started (S205). Here, if the speech of the different speaker is started, the sound analyzing section 520 records the speaker (the identification information such as ID) identified in immediately preceding S201 and the duration during which the conversation continues with the speaker (S207), and identifies the next speaker (S201), and resets the timer (S203).

On the other hand, if the speech is not started by the different speaker in S205, the sound analyzing section 520 subsequently determines whether or not the detection of the speech is continuing (S209). Here, if the detection of the speech is continuing, the sound analyzing section 205 executes the determination of S205 (and S209) again. On the other hand, if the detection of the speech is not continuing in S209, in other words, if the state without speech sound continues for a predetermined duration or more, the sound analyzing section 520 records the speaker (the identification information such as ID) identified in immediately preceding S201 and the duration during which the conversation continues with the speaker (S211), and ends the identification process of one conversation segment.

Here, for example, the sound analyzing section 520 requests the speaker identifying section 580 to identify the speaker every one second (an example of the unit time). In this case, when the above process is executed, the speaker identifying section 580 is activated every one second, to identify the speaker of the detected speech. Therefore, by counting the speaker identifying results by the speaker identifying section 580 of every second, the continuing duration of the speech of each speaker is represented by the number of times when each speaker is identified in the speaker identifying section 580. Also, if the continuing duration of the speech and the above number of times of each speaker are recorded in temporal sequence, from whom to whom the speaker is changed is known. The change of the speaker allows the situation of the conversation to be presumed, for example. For example, when the speaker is changed in the order of the father, the child, and the father, the conversation between the child and the father is supposed to have occurred. Also, when the speaker is changed in the order of the father, the mother, and the father, the conversation between husband and wife is supposed to be heard by the child. When above two changes are mixed, the conversation between the family members is supposed to have occurred.

(4. Exemplary Application)

Next, description will be made of an exemplary application of the present embodiment. Note that, in the exemplary application described below, the information accumulated by the system is handled as the information indicating the living environment characteristic of the child.

In the present exemplary application, the user for whom the information indicating the living environment characteristic is to be generated is a child. Accordingly, the wearable terminal 100 is either worn by the child, or located near the child. Further, the wearable terminal 100 is worn by another member of the family, for example, the father or the mother. As described above, the sound analyzing section 520 analyzes the sound data 510 acquired by the microphone 110 of the wearable terminal 100, in order to acquire the speech sound data 530. Further, the index calculating section 540 analyzes the speech sound data 530, in order to calculate the quantitative index 550.

(4-1. Conversation Duration)

The quantitative index 550 of the conversation in the present exemplary application includes, for example, the duration of conversation in the family. In this case, the speaker identified by the speaker identifying section 580, that is, the participant of the conversation constituted by the speech sound, includes the member of the family of the user. More specifically, the members of the family can be the father and the mother of the user (the child). The index calculating section 540 generates the quantitative index 550 including the total time of the conversation calculated for each participant (the member of the family, for example the father and the mother) of the conversation, and the information generating section 560 generates the living environment characteristic 570 on the basis of the total time of the conversation for each participant of the conversation, and thereby the information indicating the total time of the conversation with the member of the family, for example, each of the father and the mother is generated.

The above information may be used as the index indicating to what degree the user is building an intimate relationship with each of the father and the mother for example. Also, for example, the index calculating section 540 generates the quantitative index 550 including the total time of the conversation calculated for each participant (the member of the family, for example, the father and the mother) of the conversation as well as for each unit period, and the information generating section 560 generates the living environment characteristic 570 on the basis of the variation tendency of the total time of the conversation for each participant of the conversation, and thereby one can understand whether the conversation between the user and each of the father and the mother tends to increase or decrease.

Alternatively, the index calculating section 540 accumulates the total time of the conversation in the family which is calculated without identifying the speaker, over a long period of time, so that the information generating section 560 can generate the information indicating whether the user (the child) has been grown up in a living environment (boisterous or bustling living environment) rich in conversation, or in a living environment (quiet living environment) poor in conversation, on the basis of the accumulated total time, for example.

Also, the index calculating section 540 may calculate the quantitative index of the conversation, on the basis of the identification information of the speaker of the conversation recorded in temporal sequence. For example, when the speaker is changed in the order of the father, the child, and the father, the conversation between the child and the father is supposed to have occurred. Also, when the speaker is changed in the order of the father, the mother, and the father, the conversation between husband and wife is supposed to be heard by the child. When above two changes are mixed, the conversation between the family members is supposed to have occurred.

(4-2. Sound Volume of Conversation)

Also, the quantitative index 550 of the conversation in the present exemplary application may include the average sound volume and/or the maximum sound volume of the conversation in the family. In this case, the average sound volume and/or the maximum sound volume can be calculated for every predetermined time window (for example, one minute). In this case, the speaker identifying section 580 identifies the father, the mother, or another person, as the speakers for example, and the index calculating section 540 may calculate the average sound volume and/or the maximum sound volume for each participant of the conversation (including the father and the mother). Alternatively, the index calculating section 540 may calculate the average sound volume and/or the maximum sound volume, without discriminating the participant of the conversation.

For example, when the index calculating section 540 accumulates the data of the sound volume of the conversation in the family, which is calculated for each speaker, over a long period of time, the information generating section 560 can generate the information indicating to what degree the user (the child) has gotten yelled, on the basis of the duration of time or the number of times when the sound volume of the conversation with the father or the mother exceeds the normal range. In the same way, the information generating section 560 may generate the information indicating to what degree the quarrel between husband and wife has occurred, on the basis of the duration of time or the number of times when the sound volume of the conversation between the father and the mother exceeds the normal range. With this information, how the quarrel between husband and wife affects the growth of the child can be speculated. Note that, the normal range of the sound volume of the conversation may be set based on the average sound volume of the conversation which is included in the quantitative index 550, or may be given in advance, for example.

Alternatively, the index calculating section 540 accumulates the data of the average sound volume of the conversation in the family which is calculated without identifying the speaker over a long period of time, so that the information generating section 560 can generate the information indicating, for example, whether the child has been grown up in a bustling living environment (including the case where the conversation is few, but the voice is large), or in a quiet living environment (including the case where the conversation is much, but the voice is not large).

(4-3. Speed of Conversation)

Also, the quantitative index 550 of the conversation in the present exemplary application may include the average speed and/or the maximum speed of the conversation in the family. In this case, the average speed and/or the maximum speed can be calculated for every predetermined time window (for example, one minute). In this case as well, the speaker identifying section 580 identifies the father, the mother, or another person, as the speaker for example, and the index calculating section 540 may calculate the average speed and/or the maximum speed for each participant of the conversation (including the father and the mother). Alternatively, the index calculating section 540 may calculate the average speed and/or the maximum speed, without discriminating the speaker.

For example, when the index calculating section 540 accumulates the data of the speed of the conversation in the family which is calculate for each speaker over a long period of time, the information generating section 560 can generate the information indicating to what degree the user (the child) has gotten yelled, on the basis of the duration of time or the number of times when the speed of the conversation with the father or the mother exceeds the normal range. In the same way, the information generating section 560 may generate the information indicating to what degree the quarrel between husband and wife has occurred, on the basis of the duration of time or the number of times when the speed of the conversation between the father and the mother exceeds the normal range. Note that, the normal range of the speed of the conversation may be set based on the average speed of the conversation included in the quantitative index 550, or may be given in advance, for example.

Further, the information generating section 560 may generate the living environment characteristic 570, utilizing a combination of the sound volume and the speed of the conversation which is included in the quantitative index 550. For example, the information generating section 560 generates the information indicating to what degree the user (the child) has gotten yelled, on the basis of the duration of time or the number of times when the speed of the conversation with the father or the mother exceeds the normal range and the sound volume of the same conversation exceeds the normal range. In the same way, the information generating section 560 may generate the information indicating to what degree the quarrel between husband and wife has occurred, on the basis of the duration of time or the number of times when the speed of the conversation between the father and the mother exceeds the normal range and the sound volume of the same conversation exceeds the normal range. Note that, the normal ranges of the speed and the sound volume of the conversation may be set based on the average speed and the average sound volume of the conversation which are included in the quantitative index 550 or may be given in advance, for example.

In the same way, the information indicating to what degree the user (the child) rebels against his or her parents may be generated on the basis of the duration of time or the number of times when the speed of the conversation of the child toward the father or the mother exceeds the normal range and/or the sound volume of the same conversation exceeds the normal range.

Alternatively, the index calculating section 540 accumulates the data of the average speed of the conversation in the family, which is calculated without identifying the speaker, over a long period of time, so that the information generating section 560 can generate the information indicating, for example, whether the child has been grown up in a busy living environment, or in a slow living environment.

In this case as well, the data of the average speed may be utilized in combination with the data of the average sound volume. More specifically, when the average sound volume as well as the average speed of the conversation is large in the quantitative index 550, the information generating section 560 generates the information indicating that the child has been grown up in a bustling living environment. Also, when the average sound volume of the conversation is large, but the average speed is small, there is a possibility that the voice has been large but the living environment has not been bustling (homely). In the same way, when the average sound volume as well as the average speed of the conversation is small, it is speculated that the child has been grown up in a quiet living environment. On the other hand, when the average sound volume of the conversation is small but the average speed is large, there is a possibility that the living environment has included constant complaint and scolding.

Also, the information indicating the characteristic not only of the living environment of the child but also of the living environment of the parents and the brothers can be generated in the same way. For example, a short conversation duration with the father and the mother, or a short conversation duration between the father and the child may be detected, to prompt the father to make an improvement on himself, or to provide the information service and the like which is connected to the improvement. Also, the information indicating to what degree the quarrel between brothers has occurred can be generated. Further, the conversation duration or the duration during which a quarrel is supposed to be occurring may be compared with the average value of other parents or brothers, in order to generate the information indicating whether the duration is longer or shorter than the average value, or whether the frequency of the quarrel between brothers is higher or lower than the average value.

(4-4. Utilization of Data)

In recent years, where the proactive medical treatment is called for, the objective data relevant to the living environment of the user is sought to be acquired. Specifically, it is known that the living environment during childhood affects the future growth of the child significantly. The data acquired in the present exemplary application can be utilized from the following point of view, for example.

First, the data of the conversation duration in the family of the patient (the user of the subject) from past to present may be referred in the diagnosis of psychiatry or the like. In this case, for example, the information such as whether the conversation duration with the mother is long or short, whether the conversation duration with the father is long or short, whether the conversation duration with another person is long or short, as well as the information such as whether the conversation duration with the mother, the father, and another person tends to increase or decrease, are obtained. In this case, the output unit 340 of the server 300 described with reference to FIG. 2 outputs the data for reference at the site of the diagnosis.

Further, the magnitude relationship between the voices of the mother and the father and the voice of the child at the time of the conversation, as well as the information such as the sound volume of the conversation and the speed of the conversation are obtained. From these information including the conversation duration, largeness and smallness of the conversation amount during infancy, whether it has been a quiet living environment, whether it has been a bustling living environment, the frequency of getting yelled by the parents, the influence of the quarrel between husband and wife on the child, and the like, are speculated, and a diagnosis can be made based on the speculation.

Also, on the basis of the above speculation of the living environment, for example, a service that provides the environment in which one can have a lot of conversation is recommended, when it is speculated that the conversation amount is little. More specifically, the places and services in which one can interacts with other people, such as a play, English conversation, a cooking class, watching sport, and a concert, are introduced. On the other hand, a service that provides a quiet environment is recommended, when it is speculated that the conversation amount is much. More specifically, mountain trekking, a journey to touch natural environment, visiting temples, and the like, are introduced. In the same way, with regard to music, video content and the like, the recommended item is changed on the basis of the speculation of the living environment.

Although description has been made here of the case in which the information accumulated by the system is handled as the information indicating the living environment of the child, the exemplary application of the present embodiment is not limited to such example. For example, by identifying co-workers and a supervisor as the speaker, the information accumulated by the system can be handled as the information indicating an adult workplace environment. Also, when the information accumulated by the system is handled as the information indicating the living environment of the child, brothers, school teachers, friends and the like may be identified as the speaker, aside from the father and the mother.

(5. Hardware Configuration)

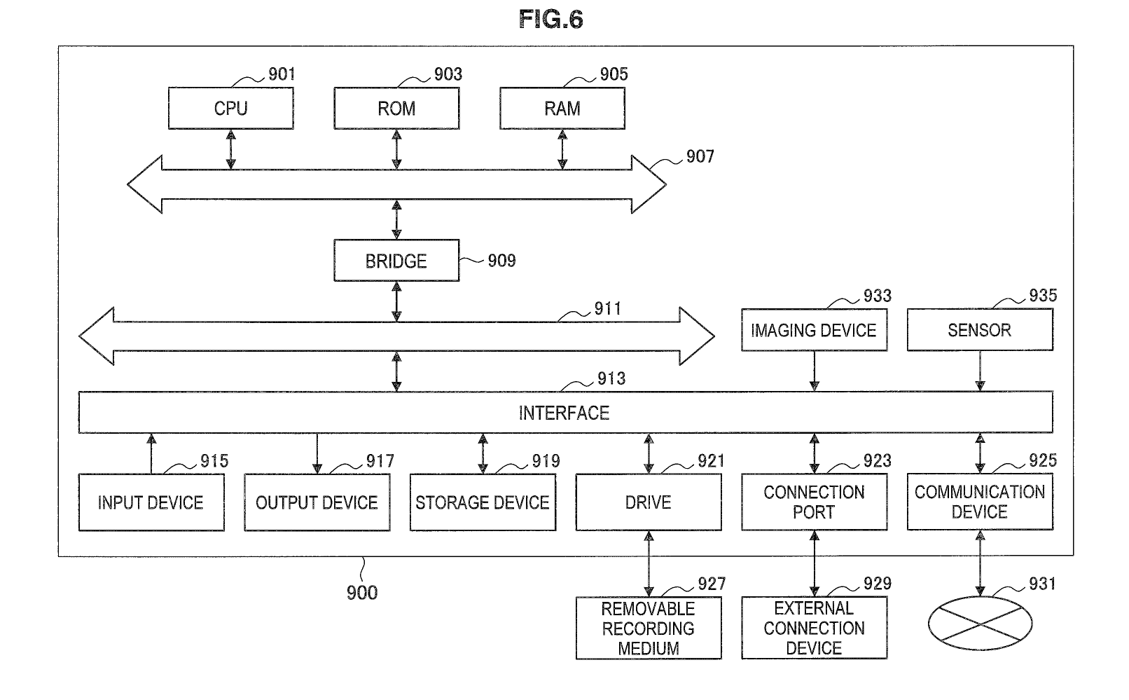

Next, with reference to FIG. 6, description will be made of the hardware configuration of the information processing apparatus according to the embodiment of the present disclosure. FIG. 6 is a block diagram illustrating the exemplary hardware configuration of the information processing apparatus according to the embodiment of the present disclosure. The information processing apparatus 900 illustrated in the drawing realizes the wearable terminal 100, the smartphone 200, and the server 300, in the above embodiment, for example.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input device 915, an output device 917, a storage device 919, a drive 921, a connection port 923, and a communication device 925. Further, the information processing apparatus 900 may include an imaging device 933 and a sensor 935 as necessary. The information processing apparatus 900 may include a processing circuit such as a DSP (Digital Signal Processor) or ASIC (Application Specific Integrated Circuit), alternatively or in addition to the CPU 901.

The CPU 901 serves as an operation processor and a controller, and controls all or some operations in the information processing apparatus 900 in accordance with various programs recorded in the ROM 903, the RAM 905, the storage device 919 or a removable recording medium 927. The ROM 903 stores programs and operation parameters which are used by the CPU 901. The RAM 905 temporarily stores program which are used in the execution of the CPU 901 and parameters which are appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input device 915 is a device which is operated by a user, such as a mouse, a keyboard, a touch panel, buttons, switches and a lever. The input device 915 may be, for example, a remote control unit using infrared light or other radio waves, or may be an external connection device 929 such as a portable phone operable in response to the operation of the information processing apparatus 900. Furthermore, the input device 915 includes an input control circuit which generates an input signal on the basis of the information which is input by a user and outputs the input signal to the CPU 901. By operating the input device 915, a user can input various types of data to the information processing apparatus 900 or issue instructions for causing the information processing apparatus 900 to perform a processing operation.

The output device 917 includes a device capable of visually or audibly notifying the user of acquired information. The output device 917 may include a display device such as an LCD (Liquid Crystal Display), a PDP (Plasma Display Panel), and an organic EL (Electro-Luminescence) displays, an audio output device such as a speaker or a headphone, and a peripheral device such as a printer. The output device 917 may output the results obtained from the process of the information processing apparatus 900 in a form of a video such as text or an image, and an audio such as voice or sound.

The storage device 919 is a device for data storage which is configured as an example of a storage unit of the information processing apparatus 900. The storage device 919 includes, for example, a magnetic storage device such as a HDD (Hard Disk Drive), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 writes in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (registered trademark) (High-Definition Multimedia Interface) port, and so on. The connection of the external connection device 929 to the connection port 923 makes it possible to exchange various data between the information processing apparatus 900 and the external connection device 929.

The communication device 925 is, for example, a communication interface including a communication device or the like for connection to a communication network 931. The communication device 925 may be, for example, a communication card for a wired or wireless LAN (Local Area Network), Bluetooth (registered trademark), WUSB (Wireless USB) or the like. In addition, the communication device 925 may be a router for optical communication, a router for ADSL (Asymmetric Digital Subscriber Line), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

The imaging device 933 is a device that generates an image by imaging a real space using an image sensor such as a charge-coupled device (CCD) or a complementary metal-oxide-semiconductor (CMOS) sensor, as well as various members such as one or more lenses for controlling the formation of a subject image on the image sensor, for example. The imaging device 933 may be a device that takes still images, and may also be a device that takes moving images.

The sensor 935 is any of various sensors such as an acceleration sensor, a gyro sensor, a geomagnetic sensor, an optical sensor, or a sound sensor, for example. The sensor 935 acquires information regarding the state of the information processing apparatus 900, such as the orientation of the case of the information processing apparatus 900, as well as information regarding the environment surrounding the information processing apparatus 900, such as the brightness or noise surrounding the information processing apparatus 900, for example. The sensor 935 may also include a Global Positioning System (GPS) sensor that receives GPS signals and measures the latitude, longitude, and altitude of the apparatus.

The foregoing thus illustrates an exemplary hardware configuration of the information processing apparatus 900. Each of the above components may be realized using general-purpose members, but may also be realized in hardware specialized in the function of each component. Such a configuration may also be modified as appropriate according to the technological level at the time of the implementation.

(6. Supplement)

The embodiment of the present disclosure can include, for example, the information processing apparatus (the wearable terminal, the smartphone, or the server), the system, the information processing method executed in the information processing apparatus or the system, which are described above, a program for causing the information processing apparatus to function, and a non-transitory tangible medium having a program stored therein.

Although the preferred embodiments of the present disclosure have been described in detail with reference to the appended drawings, the present disclosure is not limited thereto. It should be understood by those skilled in the art that various modifications, combinations, sub-combinations and alterations may occur depending on design requirements and other factors insofar as they are within the scope of the appended claims or the equivalents thereof.

The effects described in the specification are just explanatory or exemplary effects, and are not limiting. That is, the technology according to the present disclosure can exhibit other effects that are apparent to a person skilled in the art from the descriptions in the specification, along with the above effects or instead of the above effects.

Additionally, the present technology may also be configured as below:

(1) An information processing apparatus including:

an index calculating section configured to calculate a quantitative index relevant to conversation constituted by speech sound acquired by a microphone put in a living environment of a user; and

an information generating section configured to generate information indicating a characteristic of the living environment on the basis of the quantitative index.

(2) The information processing apparatus according to (1), wherein

the index calculating section calculates the quantitative index for each participant of the conversation.

(3) The information processing apparatus according to (2), wherein

the quantitative index includes a total time of the conversation, and

the information generating section generates the information on the basis of the total time of each participant of the conversation.

(4) The information processing apparatus according to (3), wherein

the participants of the conversation includes members of a family of the user, and

the information generating section generates the information on the basis of the total time for each of the members.

(5) The information processing apparatus according to (3) or (4), wherein

the total time is calculated for each unit period, and

the information generating section generates the information on the basis of a variation tendency of the total time of each participant of the conversation.

(6) The information processing apparatus according to any one of (2) to (5), wherein

the quantitative index includes a sound volume of the conversation, and

the information generating section generates the information on the basis of a duration of time or a number of times when the sound volume exceeds a normal range estimated from an average of the sound volume, with respect to each participant of the conversation.

(7) The information processing apparatus according to any one of (2) to (5), wherein

the quantitative index includes a speed of the conversation, and

the information generating section generates the information on the basis of a duration of time or a number of times when the speed exceeds a normal range estimated from an average of the speed, with respect to each participant of the conversation.

(8) The information processing apparatus according to any one of (2) to (5), wherein

the quantitative index includes a sound volume and a speed of the conversation, and

the information generating section generates the information on the basis of a duration of time or a number of times when the speed exceeds a normal range estimated from an average of the speed and the sound volume exceeds a normal range estimated from an average of the sound volume, with respect to each participant of the conversation.

(9) The information processing apparatus according to any one of (2) to (8), wherein

the quantitative index includes a sound volume or a speed of the conversation, and

the information generating section generates the information on the basis of a sound volume or a speed of the conversation that does not include the user as a participant.

(10) The information processing apparatus according to (1), wherein

the quantitative index includes a total time of the conversation, and

the information generating section generates the information on the basis of the total time.

(11) The information processing apparatus according to (1), wherein

the quantitative index includes a sound volume of the conversation, and

the information generating section generates the information on the basis of the sound volume.

(12) The information processing apparatus according to (1), wherein

the quantitative index includes a speed of the conversation, and

the information generating section generates the information on the basis of the speed.

(13) The information processing apparatus according to any one of (1) to (12), further including

a speaker identifying section configured to identify at least one of speakers of the speech sound.

(14) The information processing apparatus according to (13), wherein

the speaker identifying section separates the speakers into one or more speakers registered in advance, and one or more speakers other than the one or more speakers registered in advance.

(15) The information processing apparatus according to any one of (1) to (14), further including

a sound analyzing section configured to analyze sound data provided from the microphone, to extract data of the speech sound.

(16) The information processing apparatus according to (15), further including

a speaker identifying section configured to identify at least one of speakers of the speech sound,

wherein the sound analyzing section extracts data indicating the speakers in temporal sequence.

(17) The information processing apparatus according to (16), wherein

the sound analyzing section requests the speaker identifying section to identify speakers every unit time, and extracts data indicating the speakers in temporal sequence with a number of times when each speaker is identified in the speaker identifying section.

(18) An information processing method including:

calculating, by a processor, a quantitative index relevant to conversation constituted by speech sound acquired by a microphone put in a living environment of a user; and

generating, by the processor, information indicating a characteristic of the living environment on the basis of the quantitative index.

(19) A program for causing a computer to implement:

a function to calculate a quantitative index relevant to conversation constituted by speech sound acquired by a microphone put in a living environment of a user; and

a function to generate information indicating a characteristic of the living environment on the basis of the quantitative index.

What is claimed is:

1. An information processing apparatus comprising:
an index calculating section configured to calculate a quantitative index relevant to conversation constituted by speech sound acquired by a microphone put in a living environment of a user; and
an information generating section configured to generate information indicating a characteristic of the living environment on the basis of the quantitative index.

2. The information processing apparatus according to claim 1, wherein
the index calculating section calculates the quantitative index for each participant of the conversation.

3. The information processing apparatus according to claim 2, wherein
the quantitative index includes a total time of the conversation, and
the information generating section generates the information on the basis of the total time of each participant of the conversation.

4. The information processing apparatus according to claim 3, wherein
the participants of the conversation includes members of a family of the user, and
the information generating section generates the information on the basis of the total time for each of the members.

5. The information processing apparatus according to claim 3, wherein
the total time is calculated for each unit period, and
the information generating section generates the information on the basis of a variation tendency of the total time of each participant of the conversation.

6. The information processing apparatus according to claim 2, wherein
the quantitative index includes a sound volume of the conversation, and
the information generating section generates the information on the basis of a duration of time or a number of times when the sound volume exceeds a normal range estimated from an average of the sound volume, with respect to each participant of the conversation.

7. The information processing apparatus according to claim 2, wherein
the quantitative index includes a speed of the conversation, and
the information generating section generates the information on the basis of a duration of time or a number of times when the speed exceeds a normal range estimated from an average of the speed, with respect to each participant of the conversation.

8. The information processing apparatus according to claim 2, wherein
the quantitative index includes a sound volume and a speed of the conversation, and
the information generating section generates the information on the basis of a duration of time or a number of times when the speed exceeds a normal range estimated from an average of the speed and the sound volume exceeds a normal range estimated from an average of the sound volume, with respect to each participant of the conversation.

9. The information processing apparatus according to claim 2, wherein
the quantitative index includes a sound volume or a speed of the conversation, and
the information generating section generates the information on the basis of a sound volume or a speed of the conversation that does not include the user as a participant.

10. The information processing apparatus according to claim 1, wherein
the quantitative index includes a total time of the conversation, and
the information generating section generates the information on the basis of the total time.

11. The information processing apparatus according to claim 1, wherein
the quantitative index includes a sound volume of the conversation, and
the information generating section generates the information on the basis of the sound volume.

12. The information processing apparatus according to claim 1, wherein
the quantitative index includes a speed of the conversation, and
the information generating section generates the information on the basis of the speed.

13. The information processing apparatus according to claim 1, further comprising
a speaker identifying section configured to identify at least one of speakers of the speech sound.

14. The information processing apparatus according to claim 13, wherein
the speaker identifying section separates the speakers into one or more speakers registered in advance, and one or more speakers other than the one or more speakers registered in advance.

15. The information processing apparatus according to claim 1, further comprising
a sound analyzing section configured to analyze sound data provided from the microphone, to extract data of the speech sound.

16. The information processing apparatus according to claim 15, further comprising
a speaker identifying section configured to identify at least one of speakers of the speech sound,
wherein the sound analyzing section extracts data indicating the speakers in temporal sequence.

17. The information processing apparatus according to claim 16, wherein
the sound analyzing section requests the speaker identifying section to identify speakers every unit time, and extracts data indicating the speakers in temporal sequence with a number of times when each speaker is identified in the speaker identifying section.

18. An information processing method comprising:
calculating, by a processor, a quantitative index relevant to conversation constituted by speech sound acquired by a microphone put in a living environment of a user; and
generating, by the processor, information indicating a characteristic of the living environment on the basis of the quantitative index.

19. A program for causing a computer to implement:
a function to calculate a quantitative index relevant to conversation constituted by speech sound acquired by a microphone put in a living environment of a user; and
a function to generate information indicating a characteristic of the living environment on the basis of the quantitative index.
